(19) United States
(12) Patent Application Publication
(10) Pub. No.: US 2016/0120759 A1
(43) Pub. Date: May 5, 2016

(54) ASSISTANCE DEVICE FOR MEDICATION COMPLIANCE

(71) Applicant: i Home Smart Technology Company, New Taipei (TW)

(72) Inventors: Chia Li CHEN, Taipei (TW); Der Feng HUANG, Taipei (TW)

(73) Assignee: i Home Smart Technology Company, New Taipei (TW)

(21) Appl. No.: 14/532,106

(22) Filed: Nov. 4, 2014

(30) Foreign Application Priority Data
Nov. 4, 2014 (TW) 102220478

(51) Int. Cl. A61J 7/04; G08B 21/24

(52) U.S. Cl. CPC A61J 7/0481; G08B 21/24

(57) ABSTRACT

An assistance device for medication compliance is provided. The assistance device includes an image acquisition module, a process module, and an alarming module. The image acquisition module is configured to acquire a barcode image of a medicine information carrier. The process module receives, and identifies the barcode image acquired by the image acquisition module. The alarm module electrically connects with the process module, receives control information produced by the process module, and generates sounds or vibration to notify a user to take medicines.

### BACKGROUND OF THE INVENTION

1. Field of the Invention

The present invention is about an assistance device for medication compliance. The assistance device includes an image acquisition module, a process module, and an alarm module. The image acquisition module is configured to acquire a barcode image on a medicine information carrier. The process module electrically connects with the image acquisition module, receives and recognizes the barcode image which is acquired by the image acquisition module. The alarm module electrically connects with the process module, receives control information produced by the process module, and generates sound or vibration to notify the user to take medicines.

2. Description of the Prior Art

According to the Ministry of Interior report, form 1993, the Taiwan society had entered the aging society. By the end of the 2012, the percentage of elderly people who are over 65 years old has reached 11.2%, and the aging index further reaches 76.2%. The elderly population issue has become a mutual issue of industry, government, and academia.

With the aging of age, the physical and physiological situation of elderly people gradually declined day by day. Because the actions become inconvenient, the elderly people need to rely on the assistance of their family, and then loss sense of independence and controlling. Once the elderly people loss the two kind of senses, it make the elderly people generate a pessimism, and loss the will to survive. Therefore, in daily life, we should more respect opinion of elderly people, courage, and care them to increase their faith of life. Making the physical and psychological of elderly people staying in the health situation is an important issue. When the elderly people need to take medicines to improve the health situation, they often forget to take medicines, and it makes the health recovery slowly. The WHO report further points out that patient do not obey the medication advice is a global issue. Obeying medication advice is the key to cure disease. Hence, notify the elderly patient take medicines regularly is an important sociality issue needed to be solved in the technical field.

There are many assistance devices for taking medicine in the prior art. The main prior art technology is a storage box with electric timer or a medicine box with an alarm clock which provides timing reminder function and alarm function. In fact, many assistance devices for taking medicine provide a timing alarm which notifies the user to take medicines on time in modern market. When the users need to take multiple medicines, they need to set all kinds of medicines, respectively. It is difficult to setting multiple medication notice and maintain correct setting. If the user sets wrong settings, it might cause abuse of medications.

In addition, the Awakening News points out that, there are 136 million tons of medicines are dumped in Taiwan. The main reason is that, for symptom relief medicine such as cold medicine, antibiotic medicine, and anodyne, when the patient's condition improved, most of them stop taking medicines immediately. Furthermore, some chronic disease patients acquire a 3-month prescription from one doctor, however, before they finish their medicine, they acquire new prescription from other doctors. It wastes a lot of medicine resources.

Thus, providing a medication assistance device having notice function and medication informing function is a technical issue needed to be solved in the technical field.

### SUMMARY OF THE INVENTION

To solve the previous technical problems, one objective of the present application is providing an assistance device to improve the medicine usage situation.

To achieve the aforementioned objective, the present application provides an assistance device for medication compliance. The device comprises an image acquisition module, a process module, and an alarm module. The image acquisition module is configured to acquire a barcode on a medicine information carrier. The process module electrically connects with the image acquisition module, receives and identifies the barcode image which is acquired by the image acquisition module. The alarm module electrically connects with process module, receives control information produced by the process module, and generates a sound or vibration to notify a user to take medicines. The aforementioned function is implemented by hardware of mobile operating device (ex: cell phone, tablet, etc.). FIG. 1 shows a process procedure of present application. The barcode image acquisition step 31 which is executed though the image acquisition module 11 to acquire the barcode 21 on medicine information carrier. Then, decoding and recognizing the information contained in the barcode image (medication frequency: twice a day, four times a day) though the decoding barcode information step 32 to execute setting alarm module step 33. When executing the setting medication time step 34, the process module 12 transmits control information to alarm module 13, execute enabling alarm module step 35, and generate sound and vibration to notify a user to take medicines. After taking medicines, the user presses a particular button to execute closing alarm module step 36. If the user does not turn off the alarm module 13 in a prescribed setting time period, the process module 12 then executes transmitting short message step 37 to transmit a short message to a pre-assigned cell phone and notify a person to assist the user for taking the medicines.

Moreover, the assistance device of present application further combines a QR code as the input to store medication information (ex: medication attitude, dosing frequency, medication tine, etc) on the prescription bag. The QR code can store more medication information than the ordinary barcode. The medication information comprises medicine attitude, dosing frequency and medication time. For example, the medication attitude may record “Avoid to mix medicine with grapefruit juice, milk, tea, juice, or coffee, etc.”, the medication time may record “Daily medication time: four times a day, after breakfast, lunch, dinner, and before bedtime”, “Daily medication time: three times a day, after breakfast, lunch, and dinner”, “Daily medication time: two times a day, after breakfast and lunch”, “Daily medication time: one time a day, regular time, before meals, one hour after meals, two hour after meals”, . . . etc. The medication information can be stored by the QR code which is recorded on the prescription bag by the doctor. And the user uses the image acquisition module to capture the QR code image recorded on the prescription bag, decode the QR code, and then display the medicine information on the screen. The assistance device of present application provides a one click function to set medication time of multiple medicines by the alarm function of smart phone. Aforementioned settings are a preset setting function, and the setting values are recognized from the QR code information. The assistance device automatically sets the medication time, the total number of days, and alarm type such as ring a bell or vibration to decrease the complexity of usage. Furthermore, the assistance device of present application also provides amendment function, and allows the user to amend the alarm time, ring type, volume level, open/turn off vibration function . . . etc. The assistance device further provides a memo function, and allows the user to record memo contents. When the notice function of assistance device is enabled, the user has to press the confirm button to remove the notice function. If the assistance device does not receive the confirm information from the confirm button, the assistance device then transmits a short message to a contacts of the users, and inform that the user do not take the medicine on time. Accordingly, the assistance device can immediately notify the user to take medicines on time.

Furthermore, to conquer the disadvantage that the traditional medicine box unable to inform medication information, the assistance device pop ups a notice screen and generates rings to notify the user to take medicine. The user can press the pop screen and trigger the assistance device to display the related medication information, such as medicine name and medicine picture at left side of the screen. The user can also click to zoom in the medicine picture. The user can click the speaker icon at right side of the screen to listen the medicine description. Before taking medicine, the user can use the aforementioned function to confirm the medication time, dosage, and medication attitude whether comply the symptoms of users, confirm the medicine appearance, color whether comply the description of prescription bag, understand the side effects, important warming, taking period, total amount, retention period, approved license number, and valid date.

The assistance device of present application can promote the validity and punctuality of medicine usage so as to solve problem that the elderly people takes wrong medicine and forgets taking medicine. The assistance device can help elderly people to take medicines punctually, avoid hoarding pharmaceuticals caused by forgetting taking medicine to waste medicine, and prevent the waste of medical resources.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 shows an embodiment diagram of the assistance device for medication compliance configured in a smart phone of present application.

FIG. 2 shows a structure diagram of the assistance device for medication compliance of present application.

FIG. 3 shows an embodiment diagram of the assistance device for medication compliance of present application.

### DETAILED DESCRIPTION OF THE PREFERRED EMBODIMENT

The following description is about embodiments of the present invention; however, it is not intended to limit the scope of the present invention.

Based on aforementioned description, present application provides a notice function to notify elderly people taking medicine. If the elderly people do not take medicines, the system will inform the contacts to notify the user. Because the memory is getting worse, the assistance device of present application can inform the medication information and notify the user to take medicines on time, so as to improve the situation of medication use.

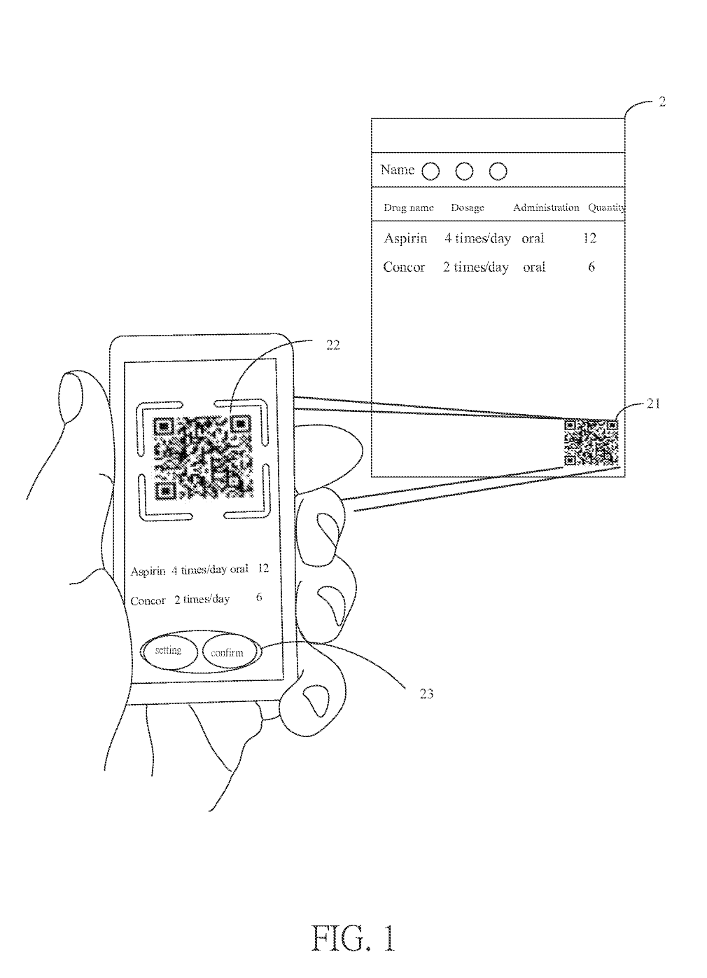

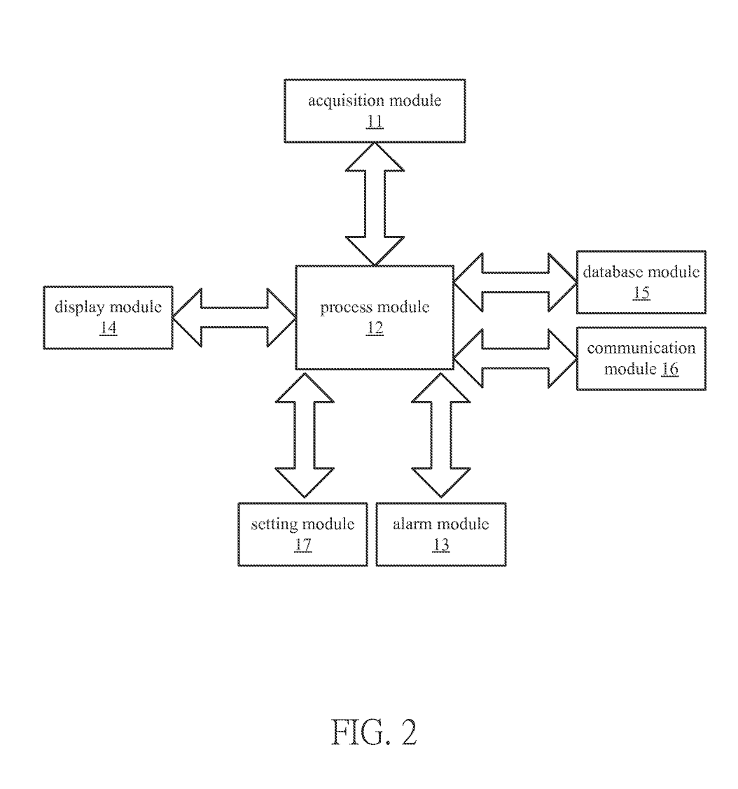

FIGS. 1 and 2 show the assistance device for medication compliance of present application. The assistance device comprises an image acquisition module 11, process module 12, and alarm module 13. The image acquisition module 11 is configured to acquire a barcode image on a medicine information carrier (ex: prescription bag). The process module receives the barcode image acquired by the image acquisition module 11, identifies the barcode image and connects with the database module 15. The display module 14, electrically connects with the process module 12, and displaying a message send by the process module 12. The alarm module 13 electrically connects with the process module 12, receives a control information generated by the process module 12, and provides sound or vibration to notify user to take the medicines.

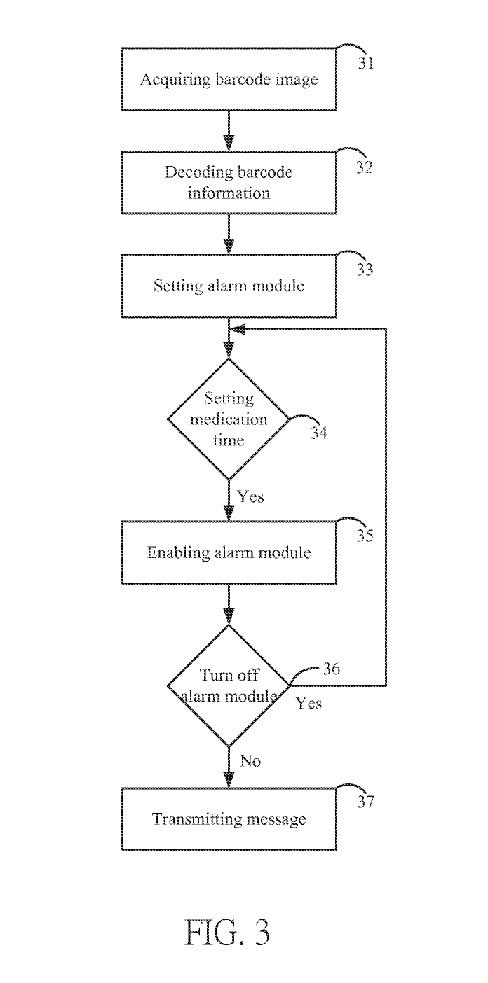

FIG. 3 shows the usage of the assistance device for medication compliance of present application. “Acquiring barcode image step 31” acquires barcode 21 of medicine information carrier 2 by image acquisition module. “decoding barcode information step 32” identifies the barcode image 22 and sets the setting module 17, setting/confirming module 23 by decoding the medicine information (medicine manner, medicine time: twice a day, four times a day) to execute “setting alarm module step 33”. When the procedure achieves “setting medicine time step 34”, the process module 12 transmits control information to alarm module 13, executes “enabling alarm module step 35”, and generates sound to notify the user to take medicines. After taking medicines, the user presses the preset button to execute “turn off alarm module step 36”. If the user doesn't turn off the alarm module 13, the process module 12 will execute “transmitting short message step 37” to transmit a short message to a pre-assigned cell phone by the communication module 16, and notify a person to assist the user to take medicines.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An assistance device for medication compliance, comprising:
an image acquisition module, configured to acquire a barcode image on a medicine information carrier;
a process module, electrically connecting with the image acquisition module, receiving and recognizing the barcode image;
a display module, electrically connecting with the process module, and displaying a message send by the process module;
a setting module, electrically connecting with the process module, and setting a process mode of the process module; and
an alarm module, electrically connecting with the process module, receiving a control information produced by the process module and generating sound or vibration to notify a user to take medicines.

2. The assistance device as claimed in claim 1, wherein the barcode image is a QR code.

3. The assistance device as claimed in claim 1, wherein the process module further connects with a database to provide medication information.

4. The assistance device as claimed in claim 1, wherein the process module further connects with a communication module, and acquires medication information from a remote database or notify a contact by the communication module.
